(19) United States
(12) Patent Application Publication
(10) Pub. No.: US 2020/0152379 A1
(43) Pub. Date: May 14, 2020

(54) INDUCTOR AND METHOD FOR MANUFACTURING SAME

(71) Applicant: ASUSTeK COMPUTER INC., Taipei (TW)

(72) Inventors: Hsi-Ho Hsu, Taipei (TW); Ming-Ting Tsai, Taipei (TW); Wei-Gen Chung, Taipei (TW); Chen-Hao Yu, Taipei (TW); Tsung-Han Wu, Taipei (TW); Hsiang-Jui Hung, Taipei (TW)

(21) Appl. No.: 16/666,921

(22) Filed: Oct. 29, 2019

(30) Foreign Application Priority Data
Nov. 14, 2018 (CN) 201811350411.8

(51) Int. Cl. H01F 41/076; H01F 41/12; H01F 27/28; H01F 27/32

(52) U.S. Cl. CPC H01F 41/076; H01F 27/327; H01F 27/2828; H01F 41/127

(57) ABSTRACT

An inductor and a method for manufacturing same are provided. The method includes: bending two ends of a wound coil towards the same side; bending the two bent ends to respectively form contact sections at the tail ends, the two contact sections are located in the same plane; and encapsulating the coil in an encapsulation body, the two contact sections are exposed outside the encapsulation body.

### CROSS-REFERENCE TO RELATED APPLICATION

This application claims the priority benefit of Chinese application serial No. 201811350411.8, filed on Nov. 14, 2018. The entirety of the above-mentioned patent application is hereby incorporated by reference herein and made a part of the specification.

### BACKGROUND OF THE INVENTION

### Field of the Invention

The disclosure relates to an electronic device and, more particularly, to an inductor and a method for manufacturing same.

### Description of the Related Art

In order to enhance the performance of a central processing unit and a graphics processor, the power capacity need to be enhanced to meet new specifications. However, it is also necessary to improve the efficiency of a power circuit due to the environmental protection and energy conservation. Therefore, an inductor in the power circuit is important to improve the efficiency of the whole circuit.

### BRIEF SUMMARY OF THE INVENTION

One of embodiments in the disclosure provides a method for manufacturing an inductor. The method includes steps of: bending two ends of a wound coil towards the same side; bending the two bent ends to respectively form contact sections at the tail ends, wherein the two contact sections are located in the same plane; and encapsulating the coil in an encapsulation body, wherein the two contact sections are exposed outside the encapsulation body.

Another embodiment of the disclosure further provides an inductor. The inductor includes: a coil, including a wound part and two foot parts, wherein the two foot parts are respectively connected to two ends of the wound part and extend towards the same side, and two contact sections are respectively formed at the tail ends of the two foot parts and are located in the same plane through bending; and an encapsulation body, surrounding the coil, wherein the two contact sections are exposed outside the encapsulation body.

In conclusion, the inductor and the method for manufacturing same according to the embodiments of the disclosure avoid the use of a lead frame. In addition, the two ends of the coil are directly exposed from the lower surface of the encapsulation body for soldering, which reduces impedance loss and improves the efficiency thus reduces electromagnetic radiation interference.

The detailed descriptions of other effects and embodiments of the disclosure are provided below with reference to the accompanying drawings.

### BRIEF DESCRIPTION OF THE DRAWINGS

To more clearly describe the technical solutions in the embodiments of this application or in the prior art, the following will briefly introduce the drawings required for describing the embodiments or the prior art. It is apparent that the drawings in the following description are only some embodiments described in this application, and a person of ordinary skill in the art may obtain other drawings on the basis of these drawings without any creative effort.

FIG. 1 is a three-dimensional schematic diagram of an inductor according to a first embodiment of the disclosure;

FIG. 2 is a flow chart of a method for manufacturing an inductor according to the first embodiment of the disclosure;

FIG. 3 is a flow chart of a method for manufacturing an inductor according to a second embodiment of the disclosure;

FIG. 4 is a top view of the inductor according to the second embodiment of the disclosure;

FIG. 5 is a flow chart of a method for manufacturing an inductor according to another embodiment of the disclosure;

FIG. 6 is a flow chart of a method for manufacturing an inductor according to another embodiment of the disclosure; and

FIG. 7 is a three-dimensional schematic diagram of an inductor according to a third embodiment of the disclosure.

### DETAILED DESCRIPTION OF THE EMBODIMENTS

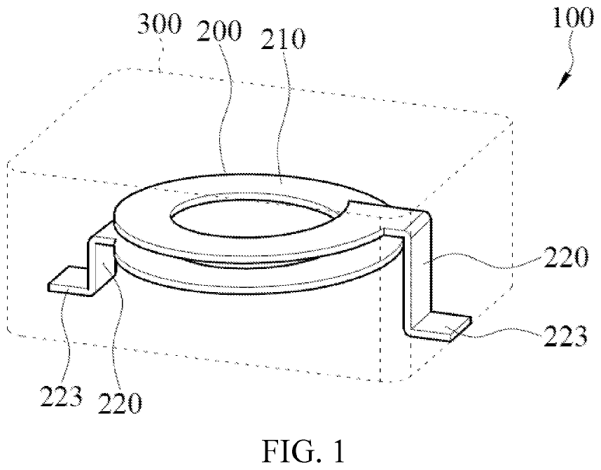

FIG. 1 is a three-dimensional schematic diagram of an inductor 100 according to a first embodiment of the disclosure. The inductor 100 includes a coil 200 and an encapsulation body 300. The encapsulation body 300 surrounds the coil 200. The coil 200 includes a wound part 210 and two foot parts 220. The two foot parts 220 are respectively connected to two ends of the wound part 210. The two foot parts 220 extend towards the same side (extending downwards as shown in FIG. 1), and two contact sections 223 are respectively formed at the tail ends of the two foot parts 220 through bending. The two contact sections 223 are exposed outside the encapsulation body 300 and located in the same plane. Here, the two contact sections 223 are located on the lower surface 310 of the encapsulation body 300 so as to be soldered on a circuit board.

In this embodiment, the coil 200 is wound by a conductive wire, and a part wound into a ring shape represents the wound part 210. The conductive wire is made of a conductive material, such as copper and other metal materials. The surface of the conductive wire has an insulating material (such as a varnished wire). The section of the wound part 210 is of a geometrical shape such as a circular shape and flat rectangular shape or other specific shapes. The encapsulation body 300 is formed by compressing a composition of soft magnetic metal powder such as iron and an adhesive such as resin.

In this embodiment, the contact sections 223 extend in opposite directions, i.e., extend outwards. However, in some embodiments, the contact sections 223 extend towards other directions. In an embodiment, they extend inwards, but the embodiments of the disclosure are not limited thereto. In one embodiment, the two contact sections 223 are not coated by insulating materials so as to be conductive with the circuit board.

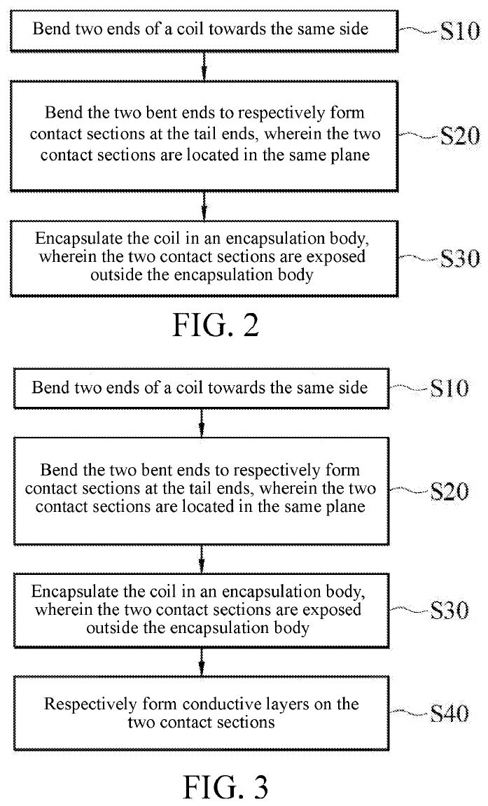

FIG. 2 is a flow chart of a method for manufacturing an inductor 100 according to the first embodiment of the disclosure. Firstly, two ends of a wound coil 200 are bent towards the same side (Step S10). Secondly, the two bent ends are bent to respectively form contact sections 223, located in the same plane, at the tail ends (Step S20). Here, the two bent ends of the coil 200 are bent in opposite directions, but the disclosure is not limited thereto. Finally, the coil 200 is encapsulated in an encapsulation body 300, and the two contact sections 223 are exposed outside the encapsulation body 300 (Step S30).

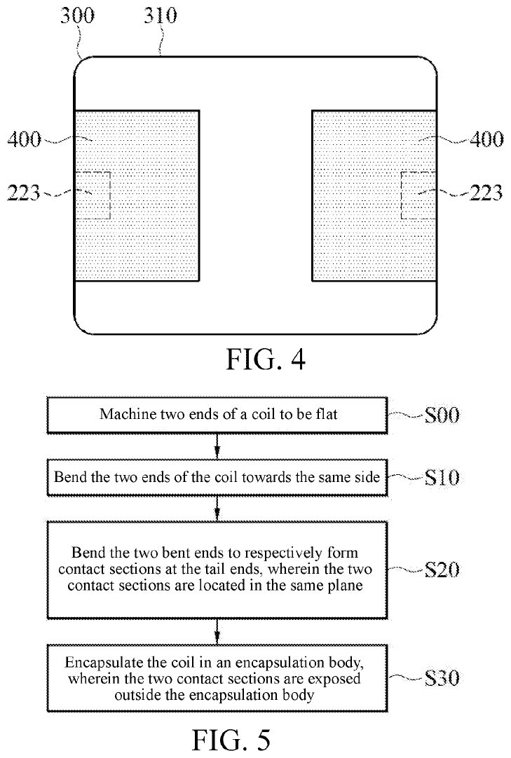

Referring to FIGS. 3 and 4 together, FIG. 3 is a flow chart of a method for manufacturing an inductor 100 according to a second embodiment of the disclosure, and FIG. 4 is a top view of the inductor 100 according to the second embodiment of the disclosure. A difference from the above-mentioned first embodiment is that the method for manufacturing an inductor 100 in this embodiment further includes Step S40 that: conductive layers 400 are respectively formed on the two contact sections 223, which makes the inductor 100 to be soldered onto a circuit board more easily and more stably. In one embodiment, the conductive layers 400 are made of a metal material such as silver, nickel and tin. The two conductive layers 400 correspondingly cover the contact sections 223. That is, the two conductive layers 400 are located on the lower surface 310 of the encapsulation body 300 and respectively connected to the two contact sections 223. The area of the conductive layer 400 is at least equal to that of the contact section 223. In the embodiment of FIG. 4, the area of the conductive layer 400 is larger than that of the contact section 223.

FIG. 5 is a flow chart of a method for manufacturing an inductor 100 according to another embodiment of the disclosure. A difference from the first and second embodiments is, before Step S10, the method for manufacturing an inductor 100 further includes Step S00 that: two ends (namely the above-mentioned two foot parts 220) of the coil 200 are machined to be flat. The machining refers to flattening. The two ends of the coil 200 are machined to be flat in a striking way, so that the area of the machined part is larger than that of the non-machined part, and thus the area of the foot part 220 is enlarged. Therefore, in this embodiment, the two bent ends are bent between the flat regions of the two contact sections (namely the above-mentioned two foot parts 220).

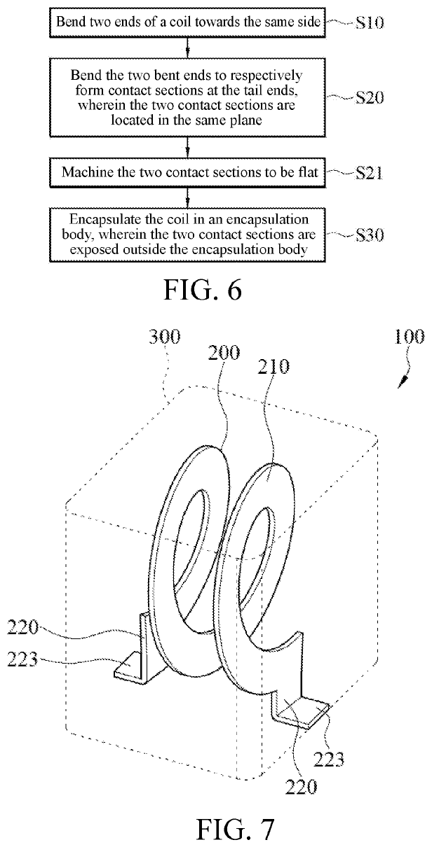

FIG. 6 is a flow chart of a method for manufacturing an inductor 100 according to another embodiment of the disclosure. A difference from the above-mentioned first and second embodiments is that in some embodiments, between Step S20 and Step S30, the method further includes Step S21 that: the two contact sections 223 are machined to be flat. In other words, unlike the embodiment in FIG. 5, only the contact sections 223 are flattened instead of the whole foot parts 220 here. The machining refers to flattening. The two contact sections 223 are machined to be flat in a striking way, so that the area of the machined part is larger than that of the non-machined part, and thus the area of the contact section 223 is enlarged.

FIG. 7 is a three-dimensional schematic diagram of an inductor 100 according to a third embodiment of the disclosure. It is to be noted that the coil 200 in the above-mentioned embodiments is wound approximately along a direction parallel to the bottom surface of the encapsulation body 300 (that is, the axis of the coil 200 is substantially perpendicular to the bottom surface of the encapsulation body 300), but the embodiments of the disclosure are not limited thereto. In an embodiment, as shown in FIG. 7, the coil 200 is wound approximately along a direction perpendicular to the bottom surface of the encapsulation body 300 (that is, the axis of the coil 200 is substantially parallel to the bottom surface of the encapsulation body 300).

In conclusion, the inductor 100 and the method for manufacturing same according to the embodiments of the disclosure avoid use of a lead frame in the prior art. In addition, the two ends of the coil 200 are directly exposed from the lower surface 310 of the encapsulation body 300 for soldering, which reduces impedance loss so as to improve the efficiency and reduces electromagnetic radiation interference.

The above-described embodiments and/or implementations are merely illustrative of preferred embodiments and/or implementations for practicing the techniques of the disclosure, and are not intended to limit the embodiments of the techniques of the disclosure in any manner, and any person skilled in the art may make various variations or modifications to obtain other equivalent embodiments without departing from the scope of the technical means disclosed herein, and all such embodiments should still be considered to be substantially the same techniques or embodiments as the disclosure.

What is claimed is:

1. A method for manufacturing an inductor, comprising:
bending two ends of a wound coil towards the same side;
bending the two bent ends to respectively form contact sections at the tail ends, wherein the two contact sections are located in the same plane; and
encapsulating the coil in an encapsulation body, wherein the two contact sections are exposed outside the encapsulation body.

2. The method for manufacturing an inductor according to claim 1, further comprising: machining the two contact sections to be flat.

3. The method for manufacturing an inductor according to claim 2, wherein the two bent ends are bent between the flat regions of the two contact sections.

4. The method for manufacturing an inductor according to claim 1, wherein the two bent ends of the coil are bent in opposite directions.

5. The method for manufacturing an inductor according to claim 1, further comprising: respectively forming conductive layers on the two contact sections.

6. An inductor, comprising:
a coil, comprising a wound part and two foot parts, wherein the two foot parts are respectively connected to two ends of the wound part and extend towards the same side, and two contact sections are respectively formed at the tail ends of the two foot parts located in the same plane through bending; and
an encapsulation body, surrounding the coil, wherein the two contact sections are exposed outside the encapsulation body.

7. The inductor according to claim 6, wherein the two foot parts are flat.

8. The inductor according to claim 6, wherein the two contact sections are flat.

9. The inductor according to claim 6, wherein the two contact sections extend in opposite directions.

10. The inductor according to claim 6, further comprising: two conductive layers, respectively located on the two contact sections.
